(19) United States
(12) Patent Application Publication
(10) Pub. No.: US 2009/0250353 A1
(43) Pub. Date: Oct. 8, 2009

(54) Nanoporous Material

(76) Inventors: Aicheng Chen, Thunder Bay (CA); Kallum Koczkur, Guelph (CA); Jingpeng Wang, Thunder Bay (CA)

Correspondence Address: POTTER ANDERSON & CORROON LLP;ATTN: JANET E. REED, PH.D., P.O. BOX 951, WILMINGTON, DE, 19899-0951, US

(21) Appl. No.: 12/302,710

(22) PCT Filed: May 25, 2007
(86) PCT No.: PCT/CA07/00935

§ 371 Date: Jun. 10, 2009

Related U.S. Application Data
(60) Provisional application No. 60/803,325, filed on May 26, 2006.

(51) Int. Cl. G01N 27/416; B44C 1/22; C25D 5/34; B32B 3/10; G01N 27/26; G01N 27/327; B01J 23/42

(52) U.S. Cl. 205/210; 216/83; 428/338; 205/775; 252/182.1; 205/794.5; 205/792; 205/788; 502/101; 502/334

(57) ABSTRACT

A method of fabricating a nanoporous material, the method comprising the steps of: (i) heating a substrate in the presence of at least one reducing agent and at least one precursor solution; and (ii) cooling the resulting nanoporous material. The nanoporous material may be used for detection of a substrate, for an electrode in a fuel cell, and as a catalyst in the electro-oxidation of an organic species.

### FIELD

The invention relates to nanoporous compositions, and more particularly to nanoporous materials comprising platinum, processes of making them, and methods of using them.

### BACKGROUND OF INVENTION

Nanoporous materials have high surface areas that impart unique physical and chemical properties to the materials. Some of these materials have a number of applications in the area of, for example, catalysis, fuel cells, and chemical sensors. Nanostructured platinum (Pt) materials have particularly useful electrocatalytic properties.

Several species such as tin (Sn), iridium (Ir), osmium (Os), ruthenium (Ru), tungsten (W), and Pt have been extensively studied in an effort to improve catalytic performance for such applications as the direct methanol fuel cell (DMFC). Currently, bimetallic platinum-ruthenium particles and thin films have been shown to exhibit the best activity. One limiting factor in the DMFC is the formation of the carbon monoxide (CO) intermediate from the partial oxidation of methanol. CO, a catalyst poisoning species, is chemisorped and significantly degrades the overall performance of the fuel cell. The addition of ruthenium to platinum has been shown to promote the oxidation of CO to carbon dioxide (CO₂) by way of a bifunctional mechanism. Alternatively, the ligand effect mechanism, proposes an enhancement of platinum catalytic activity by way of a PtRu orbital overlap, Which modifies the electronic properties of platinum.

Nanoporous materials show promise as electrochemical sensors. For example, there is interest in developing precise and quick methods to monitor blood sugar levels for purposes of controlling and treating diabetes. Electrochemical biosensors in particular have received much attention recently for glucose detection due to their quick, concise readings using a disposable tip, which eliminates the possibility of instrument contamination.

Several processes have been developed for the preparation of nanoporous materials. For example, the present inventors have disclosed a process for making Pt nanoporous materials using electrochemical depositions (Peng, X. S., Koczkur, K., Nigro S., and Chen, A. C., 2004, Chem. Commun. 2872, incorporated herein by reference). Other processes involve multiple steps to fabricate the nanoporous materials, such as electrochemical deposition(s), template directed synthesis, multiple hydrothermal treatments, and drying the electrodes under heated air streams or under argon at elevated temperatures.

### SUMMARY OF INVENTION

The present invention provides Pt-based nanoporous materials, processes of fabricating thereof, uses thereof, and methods of using thereof.

According to one aspect of the present invention, a method of fabricating Pt-based nanoporous materials is provided, the method comprising the steps of optionally washing a substrate, the substrate comprising titanium, tantalum, zirconium, platinum, gold, or carbon; etching the substrate to substantially remove any oxide layer from the substrate; heating the substrate in an apparatus such as an autoclave, the apparatus containing at least one reducing agent and at least one precursor solution; and cooling and removing the resulting nanoporous material from the autoclave. The nanoporous material may optionally be washed again with a suitable solvent. Optionally, Pt nanoparticles are electrodeposited on the etched substrate at a suitable current after the etching step.

According to another aspect of the invention, nanoporous Pt-based materials fabricated by the method above are provided.

According to another aspect of the invention, uses of the nanoporous Pt-based materials are provided. The uses include detection of a substrate, wherein the substrate is a biochemical substrate, wherein the biochemical substrate can be a saccharide such as glucose, galactose, fructose, lactose, maltose, or sucrose. The substrate may also be an alcohol such as methanol, ethanol, isopropanol, or the like, or may be carbon monoxide or carbon dioxide. The nanoporous Pt-based materials provided herein can also be used as electrodes in fuel cells, such as in a direct methanol fuel cell. They may also be used as catalysts in the electro-oxidation of species, such as organic species.

According to another aspect of the invention, a method of detecting a biochemical substrate using the nanoporous Pt-based materials provided herein are provide. The method comprises the steps of obtaining the nanoporous Pt-based material that reacts with the biochemical substrate to produce a signal, contacting a sample solution expected to contain the biochemical substrate with the nanoporous Pt-based material, and detecting the signal. The signal may be an electric signal and it may be detected by a response current generated by applying a voltage to the nanoporous Pt-based material. It is preferred that the nanoporous Pt-based material is substantially free of any immobilized enzyme. The biochemical substrate can be a saccharide such as glucose, galactose, fructose, lactose, maltose, or sucrose. The biochemical substrate can be measured in a sample of water, blood, urine, serum, or PBS buffer. The current can be measured amperometrically. The range of applying the voltage can be between about −0.4 V and 0.5 V versus a reference electrode, and the reference electrode can be Ag/AgCl. It is preferred that the current generated is proportional to glucose present in the sample from a range of about 0 to about 50 mM, more preferably in the range of about 0 to about 30 mM, and even more preferably in the range of about 20 mM glucose.

According to another aspect of the invention, there is provided a method of manufacturing a biochemical substrate detector, comprising the step of providing the detector with the nanoporous Pt-based material provided by the present invention. The biochemical substrate can be a saccharide such as glucose, galactose, fructose, lactose, maltose, or sucrose.

According to another aspect of the present invention, there is provided a biochemical substrate detector comprising a nanoporous Pt-based material provided by the present invention. The biochemical substrate can be a saccharide such as glucose, galactose, fructose, lactose, maltose, or sucrose.

According to another aspect of the present invention, there are provided fuel cell electrodes comprised of nanoporous Pt-based materials provided herein. The fuel cell electrodes can be used in direct methanol fuel cells.

According to another aspect of the present invention, there is provided a method of using fuel cells comprising a nanoporous Pt-based material provided herein, the method comprising the step of contacting a fuel to the nanoporous Pt-based material. The fuel may be a lower alcohol such as methanol or ethanol.

### BRIEF DESCRIPTION OF THE FIGURES

The invention is illustrated in the figures of the accompanying drawings which are meant to be exemplary and not limiting, and in which:

FIGS. 1 (a) to (d) are scanning electron micrographs (SEMs) of nanoporous Pt-based materials of the present invention.

FIG. 2 show EDS results for the materials shown in FIG. 1.

FIG. 3 shows XRD results for the materials shown in FIG. 1.

FIGS. 4 (a) and (b) show cyclic voltammograms of an electrode of the present invention and Pt wire.

FIGS. 5 (a) and (b) show amperometric responses of nanoporous materials of the present invention compared to Pt wire.

FIGS. 6 (a) and (b) show cyclic voltammograms of electrodes/nanoporous materials of the present invention and Pt wire.

FIGS. 7 (a) to (d) show cyclic voltammograms of electrodes/nanoporous materials of the present invention and Pt wire and chronoamperometry and electrochemical impedance spectra results from the electrodes/nanoporous materials.

FIG. 8 shows cyclic voltammograms of electrodes/nanoporous materials of the present invention and Pt wire.

FIG. 9 shows chronoamperometry results for electrodes/nanoporous materials of the present invention and Pt wire

FIG. 10 shows a SEM image of a typical nanoporous Pt—Ir surface and the cyclic voltammograms of bulk Pt and the nanoporous Pt₅₀Ir₅₀ in 0.5M H₂SO₄+0.1 CH₃OH at a sweep rate of 20 mV/s.

FIG. 11 shows a SEM image of a typical nanoporous Pt—Pb surface and the electrochemical response of the invented nanoporous Pt—Pb catalyst on glucose in 0.1M phosphate buffer solutions at a scan rate of 10 mV/s.

### DETAILED DESCRIPTION OF THE PREFERRED EMBODIMENTS

The present invention relates to nanoporous materials comprising Pt, PtₓA_{y} or PtₓA_{y}B_{z}, wherein A and B are the same or different, and represent Ru, Ir, Os, Bi (bismuth), Pb (lead), Pd (palladium), Rh (rhodium) or W; x can be selected from the percent range of about 10% to about 100%, or from the percent range of about 20% to about 80%, or from the percent range of about 40% to about 60%; and (y+z) can be selected from the percent range of about 90% to about 0%, or from the percent range of about 80% to about 20%, or from the percent range of about 60% to about 40%. This invention also relates to processes for making and methods of using the nanoporous materials.

The nanoporous materials comprising Pt of the present invention are synthesized according to the process represented by the following steps:

(i) a suitable substrate is washed with a suitable solvent. The substrate can be manufactured from or comprise Ti, Ta (tantalum), Zr (zirconium), Pt, Au (gold), or suitable alloys thereof, or may be carbon, such as carbon nanotube. The substrate can be any shape, such as foil, sheet, rod, wire, and mesh. For example, the substrate can be Ti foil. Solvents suitable for washing the substrate include, but are not limited to, acetone, methanol, ethanol, and iso-propanol. It will be recognized by a person skilled in the art that there are many solvents and mixtures of solvents, including organic solvents, that can used. The substrate can be rinsed with purified water following the solvent wash. The water can have a purity of at least 10 MΩ·cm (megaohm centimeter), and can have a level of purity of at least 15 MΩ·cm. It will be recognized by the skilled person that another pure solvent could be used instead of water, such as ethanol.

The washing step (i) is optional and is performed as required to ensure that the surface of the substrate is suitably clean.

(ii) If the substrate has or is thought to have an oxide layer on its surface, as is often the case when using substrates comprising Ti, Ta, or Zr, the substrate can be etched using an acidic solution in order to substantially remove the oxide layer. Suitable acids include hydrochloride acid, nitric acid, or sulfuric acid, or mixtures thereof with strengths ranging from about 3% to about 50%, or in the range of about 5% to about 40%, or in the range of about 10% to about 35% of suitable strength and at a suitable temperature for a suitable time. The etching process can be conducted at a temperature in the range of room temperature to about 100° C. (degree Centigrade), or in the range of about 40° C. to about 90° C., or in the range of about 50° C. to about 85° C. The etching time can be a few seconds to a few hours depending on the temperature and the concentration of the acid, and it is within the ability of the skilled person to determine suitable length of time.

(iii) Optionally, Pt nanoparticles can be electrodeposited on the etched substrate at a suitable current (milliamps per centimetres squared) for a suitable length of time from a solution comprising a Pt based compound and an acid, such as H₂PtCl₆ and HCl. The present invention also includes processes which omit an electrodeposition step.

(iv) This step can be referred to as the hydrothermal step. The substrate can be transferred into an apparatus such as an autoclave, the apparatus containing at least one reducing agent and at least one precursor solution. Suitable reducing agents include ethylene glycol, formaldehyde, formic acid, and NaBH₄. It is preferred that ethylene glycol is not used for reducing both platinum and ruthenium at the same time, as incomplete results may be obtained. However, the inventors have found that formaldehyde can reduce Pt and Ru, for example, in a single step. The precursor solution can comprise M1, M1+M2 or M1+M2+M3, where M1 can be H₂PtCl₆.xH₂O (x is in the rang between 0 and 6), PtCl₄ or PtCl₂ X g/L (X can be in the range of about 0.1 and 32, or in the range of about 0.4 to about 10, or in the range of about 0.6 to about 5, or in the range of about 0.8 to about 3.8); M2 and M3 can be IrCl₃.yH₂O (y in the range 0 to 3), RuCl₃.yH₂O (y in the range 0 to 3), BiCl₃, AuCl₃, RhCl₃, PbCl₂, PdCl₂, WCl₆ X g/L (X can be in the range of about 0.1 and 32, or in the range of about 0.4 to about 10, or in the range of about 0.6 to about 5, or in the range of about 0.8 to about 3.8). As the skilled person will appreciate, other compounds will be suitable for use with this step of the method. The pH of the precursor solution can be lower than 7, and can be lower than 5. The pH of the precursor solution can be adjusted by adding such components as HCl, H₂SO₄, H₃PO₄, HCOOH, CH₃COOH or HOOC—COOH, The substrate can be heated in the presence of the at least on reducing agent and at least one precursor solution for a suitable temperature and for a suitable period of time. The temperature can be in the range of about 80° C. and about 240° C., or in the range of about 100° C. to about 220° C., or in the range of about 120° C. and about 200° C. For example, the temperature can be about 180° C. The time period of this step can be in the range of about a few minutes to about several days, or in the range of about 5 minutes to about 24 hours, or in the range of about 10 minutes to 15 hours. The time period depends in part on the temperature used.

(v) After cooling to room temperature, the sample is taken out from the autoclave, and dried. It can optionally be washed again with a suitable solvent, such as acetone or pure water to produce a nanoporous Pt-based material, also referred to as an electrode.

The nanoporous materials described herein comprise pores with diameters in the range of about 0.1 nm (nanometer) to about 1 micrometer, or in the range of about 0.5 nm to about 500 nm, or in the range of about 1 nm to about 100 nm, in at least one dimension. The nanoporous materials are substantially non-mesoporous. The term “mesoporous” in reference to a material will be recognized by the skilled person as meaning a porous material with regularly arranged, uniform pores usually having a diameter in the range of about 2 nm to about 50 nm. As used herein, the term “non-mesoporous” refers to a material that substantially does not have regularly arranged, uniform pores as does a mesoporous material. As used herein, the term “non-mesoporous” is not intended to refer to materials having or not having pore diameters of a particular size.

The nanoporous materials described herein have relatively large surface areas and exhibit

improved electrochemical activity.

The nanoporous materials described herein can be useful for a number of applications. In particular, the nanoporous materials can be highly sensitive and selective biochemical compound sensors for biochemical compounds such as glucose, ethanol, and carbon monoxide. They can be suitable for sustaining sensitivity and selectivity under physiological glucose levels (3-8 mM), for example. The nanoporous materials can also be useful for use in fuel cells, such as a direct methanol fuel cell, for example, and in catalysis.

Embodiments of the invention are described in the following examples. The examples are meant to be exemplary only, and are not intended to limit the scope of the invention.

### Example 1

Products made by the following process are useful for the applications disclosed herein.

A titanium (Ti) foil was washed with acetone followed by Nanopure water (18.2 megaohm cm), then etched in 30 weight % hydrochloric acid (HCl) at 80° C. for 10 minutes to remove the thin oxide layer on the titanium surface. Then Pt nanoparticles were electrodeposited in the etched Ti substrate at −20 milliamps (mA) centimetres-2 (cm-2) for 3 minutes from a solution composed of H₂PtCl₆ 0.8 g/L and HCl 0.3 g/L. The treated Ti substrate was transferred into an autoclave containing ethylene glycol (EG), H₂PtCl₆ 0.8 g/L and HCl 0.3 g/L, and heated at 100 degC for 10 hours. After cooling to room temperature, the sample was washed again in acetone and Nanopure water to produce the nanoporous Pt network electrodes.

### Example 2

Electrodes, with varying compositions of PtRu, were produced by changing the amount of precursor solution prior to hydrothermal treatment. Activities in 0.1 M phosphate buffered saline (PBS, pH 7.4) were compared with and without 0.15 NaCl.

Nanoporous PtRu nanomaterial electrodes were made in the following manner: pieces of titanium foil were washed with Nanopure water (18.2 MΩ cm), then etched in an 18% HCl solution at 85° C. for 10 minutes to remove the oxide layer on the titanium surface. The etched substrate pieces were then washed once more and transferred to a teflon autoclave containing formaldehyde (CH₂0), H₂PtCl₆*6H₂O, RuCl₃*3H₂O, and HCl and heated at 180° for 10 hours. After cooling to room temperature, the coated substrates were removed, air dried, then rinsed with Nanopure water. This process resulted in the synthesis of the 3D nanoporous PtRu nanomaterial electrodes.

Electrochemical experiments including cyclic voltammometry (CV) and chronoamperometry (CA) were performed with a three-electrode cell system which includes the working electrode, platinum wire as the counter electrode, and silver chloride as the reference electrode. Data acquisition and analysis were done with a CH Instruments CH1660B potentiostat. The geometric surface area of each electrode was used to calculate the current density. The electrolytes were prepared with KH₂PO₄ (Aldrich, 99%), NaCl (Anachemia, 99%), glucose (BDH, analytical grade) and pure water (Nanopure, 18.2 Mg cm). Ultrapure argon (BOC GASES, 99.999%) was used to deaerate all solutions prior to measurements, and passed over top of the solution during testing. All measurements were conducted at room temperature.

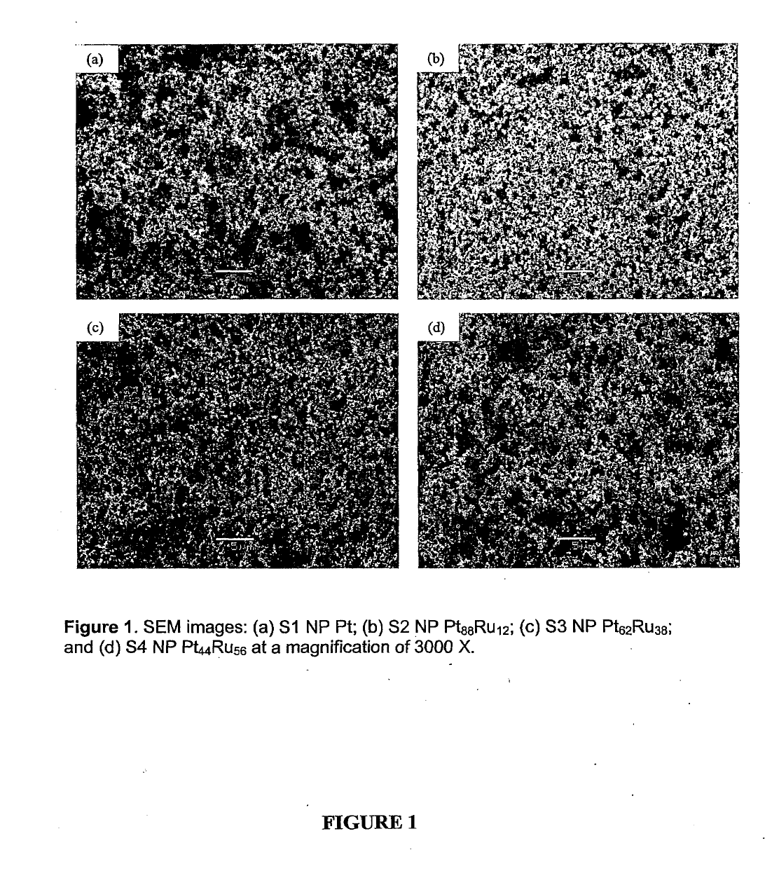

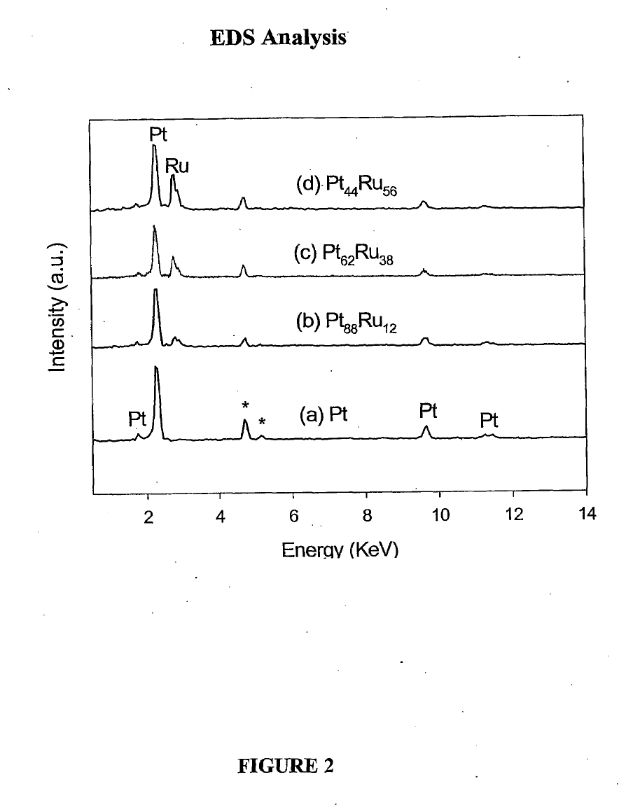

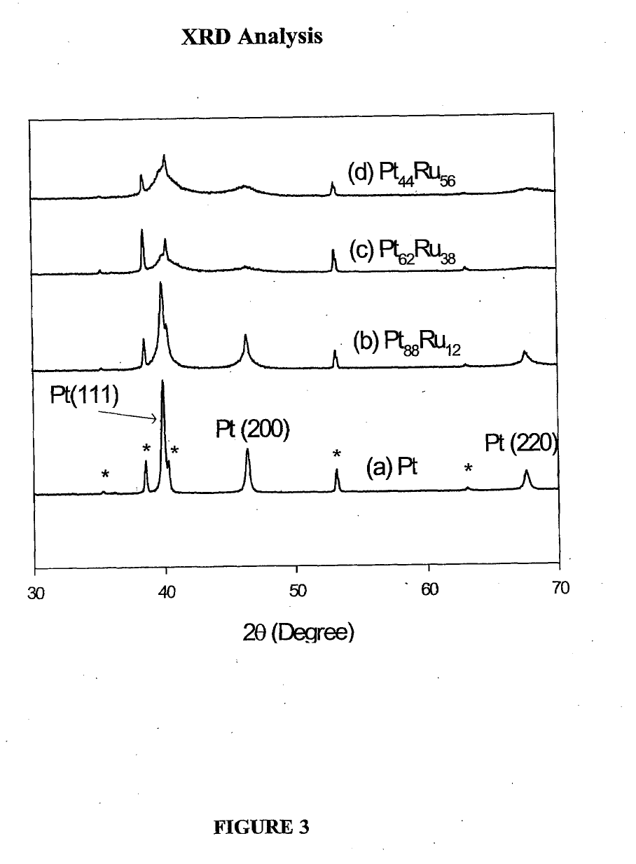

Scanning electron microscopy (SEM) was used to characterize the surface morphologies of 3D nanoporous PtRu alloy network electrodes after hydrothermal treatment. FIGS. 1(a) to (d) show SEM images containing excellent coverage of the substrate for samples of NP (nanoporous) Pt (S1), NP Pt/Ru-12% (S2), NP Pt/Ru-38% (S3), and NP Pt/Ru-56% (S4), respectively. The increase in diameter of the porous networks could be readily observed when ruthenium was present along with the platinum, with a range in size from 10's to 100's of nanometers. Further analysis of the sample was done by energy dispersive x-ray spectrometry (EDS) and x-ray diffraction (XRD). Asterisks in FIG. 2 and FIG. 3 denote titanium derived from the substrate. The EDS spectra shown in FIG. 2 indicate the increase in ruthenium concentration from S1 to S4. XRD patterns in FIG. 3 indicate peaks consistent with the face-center-cubic (fcc) pattern anticipated for platinum rich PtRu alloys. A decrease in platinum concentration as ruthenium concentration increases was observed; however, no diffraction peak for ruthenium was observed which would suggest that a PtRu alloy was formed on the surface of the sample.

Based on the SEM analysis, without being bound the theory, the inventors propose a seed growth method. At appropriate temperature and pressure, the formaldehyde reduces the platinum from Pt⁴⁺ to Pt⁰ and ruthenium from Ru³⁺ to Ru⁰ resulting in deposition on the titanium substrate surface. As reduction continues, the surface of the substrate becomes covered until the nanoparticles start forming on top of one another culminating in the formation of the nanoporous PtRu nanomaterial electrodes.

### Example 3

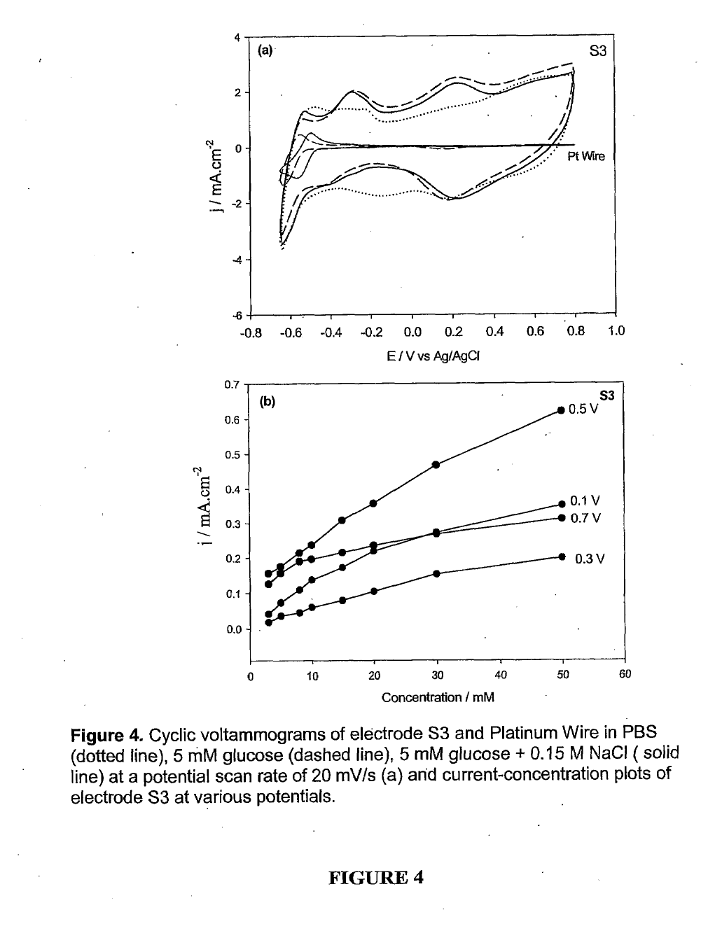

Electrochemical properties of the electrodes fabricated in Example 2 were determined by methods including cyclic voltammometry and chronoamperometry. FIG. 4(a) shows medium range CV scans for Pt and S3. As shown in FIG. 4(a), the nanomaterial electrode with the same geometric surface area, exhibited vastly superior performance towards glucose oxidation over platinum wire. Also in FIG. 4(a), CV scans in 0.1 M PBS (dotted line), without 0.15 M NaCl at a glucose concentration of 5 mM (dashed line) and with 0.15 M NaCl at a glucose concentration of 5 mM (solid line), are shown for S3. The effect of the chloride ion in solution had a very small impact of glucose-oxidation ability of the electrode. Current-concentration curves at potentials of 0.1 V, 0.3 V, 0.5 V, and 0.7 V are presented for sample S3 in FIG. 4(b). A potential of 0.3 V produced the lowest sensitivity readings while 0.1 V and 0.7 V indicated similar sensitivities, albeit slightly higher than 0.3 V. The results indicate that the optimum potential for amperometric glucose sensing was 0.5 V with a sensitivity of 0.032 mA/cm² mM at a 6 mM glucose concentration.

### Example 4

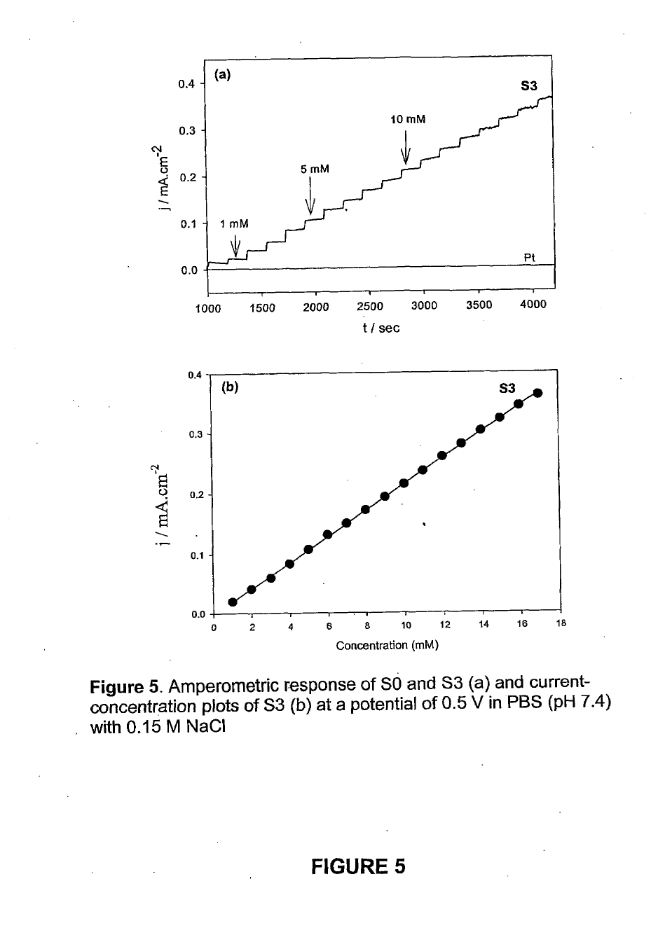

The electrocatalytic activity of the electrodes at fixed potentials and for time after injections of glucose were studied in order to further evaluate the electrodes sensing ability. FIG. 5a presents the amperometric response with successive additions of glucose into a 0.15 M NaCl+0.1 M phosphate buffer solution (pH 7.4), recorded under a stirred system at the potential of 0.45 V. S3 showed an excellent response to glucose. A linear dependence to glucose was observed in the range from 0.5 mM to 17 mM with a correlation coefficient R of 0.999 as shown in FIG. 5b; while no amperometric response was observed for the polycrystalline Pt surface (S0) as shown in FIG. 5a. Electrode S3, with a ruthenium concentration of 38%, exhibited excellent performance and sensitivity towards glucose oxidation despite the presence of a highly concentrated chloride ion (0.15 M vs 0.1 M in physiological conditions).

### Example 5

To further characterize and test the electrodes fabricated in Example 2, electrochemical experiments including CV, CA, & EIS, were performed with a 3 electrode cell system as described above. Data acquisition and analysis were done with a Solartron 1287 potentiostat, a Solartron 1252A frequency response analyzer in addition to CorrWare and Zplot software. The geometric surface area of each electrode was used to calculate the current density. EIS measurements had an amplitude of modulation potential of 10 mV and a frequency range of 40 kHz to 40 mHz. The electrolytes were prepared with H₂SO₄ (Aldrich, 99.999%), methanol (Calcdon, 99.9%) and pure water (Nanopure, 18.2 MD cm). Carbon monoxide (PRAXAIR, 99.9%) was used for the CO study. Ultrapure argon (BOC GASES, 99.999%) was used to deaerate all solutions prior to measurements, and passed over top of the solution during testing. All measurements were conducted at room temperature.

### Example 6

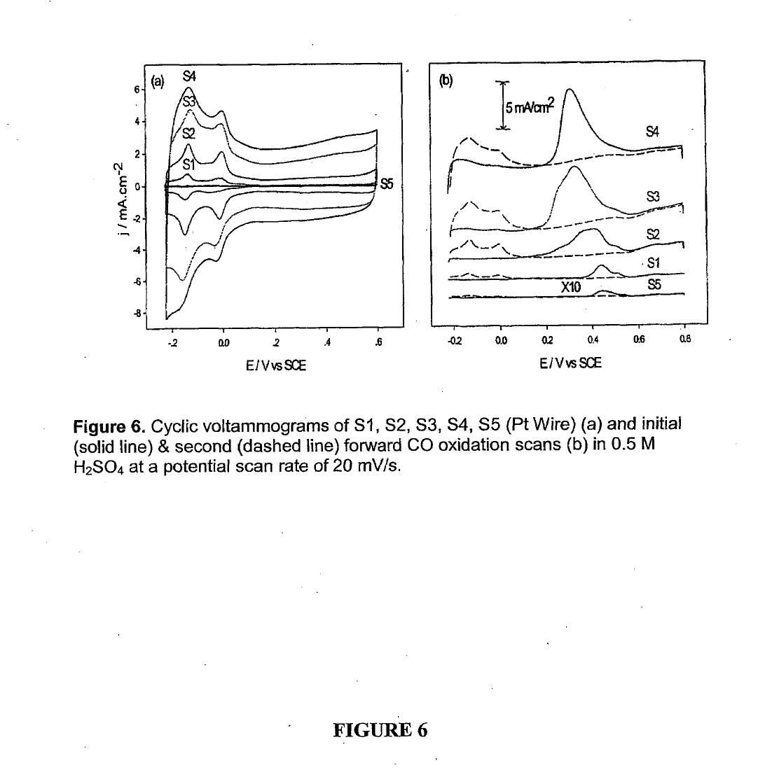

Electrochemical studies, as described above, were used to evaluate the electrochemical properties of the 3D alloy electrodes. The adsorption and desorption of hydrogen is a technique used to determine the active surface area of the platinum electrode. As the ruthenium concentration of the electrodes increased, the double layer capacitance increased while the structure of the hydrogen region became less defined. These observations were consistent with those of the prior art. FIG. 6(a) shows a short range CV scan for S1, S2, S3, S4 and S5 (Pt Wire) in a 0.5 M H₂SO₄ solution at a potential scan rate of 20 mV/s. The hydrogen adsorption/desorption peaks for each sample were consistent with a slight shift from polycrystalline Pt (ca. 0.00025 V, −014V) to S4 (ca. −0.026 V, −0.17V). The actual surface area of the electrodes was equivalent to the number of Pt sites available for hydrogen adsorption/desorption. In calculating the adsorption charge, integrated area under the peaks, it was assumed that the double layer capacitance was constant across the entire potential range. The hydrogen adsorption charge (Q_{H}) of polycrystalline Pt was calculated at 0.21 mC/cm². Samples St, S2, S3, and S4 produced Q_{H}'s of 4.85, 16.01, 28.48, and 30.23 mC/cm². These results show that the surface area of these samples was many times that of polycrystalline Pt, especially S3 and S4 whose actual surface areas are well in excess of 100 times greater.

One factor in the DMFC is efficient removal of the CO catalyst poison species. FIG. 6(b) shows initial (solid line) and second (dashed line) forward CV scans in 0.5 M H₂SO₄ after purging the solution with CO. All samples showed a similar broad peak for the oxidation of CO. The CO oxidation peak was centered around 0.44 V for S5 and as the ruthenium concentration increases, the peak was shifted to a lower potential with S4's peak being located at 0.3 V. On the second forward scan, the CO had been completely oxidized and the hydrogen adsorption was no longer suppressed. The charge for the CO oxidation, Q_{CO}, was calculated in a manner similar to that previously mentioned, and once again, the activity of S3 and S4 was in excess of 100 times that of S5.

### Example 7

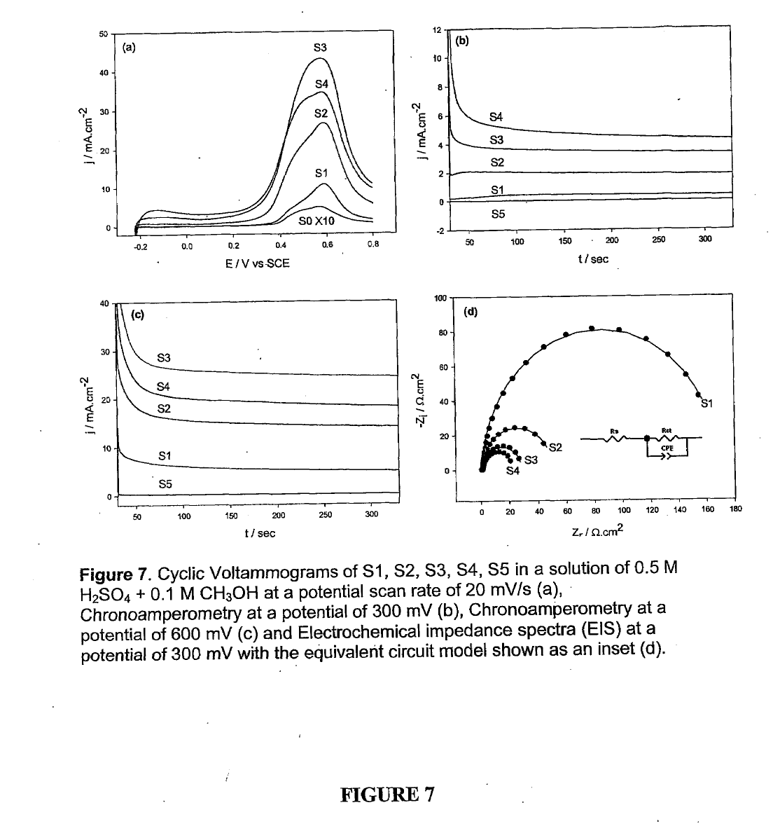

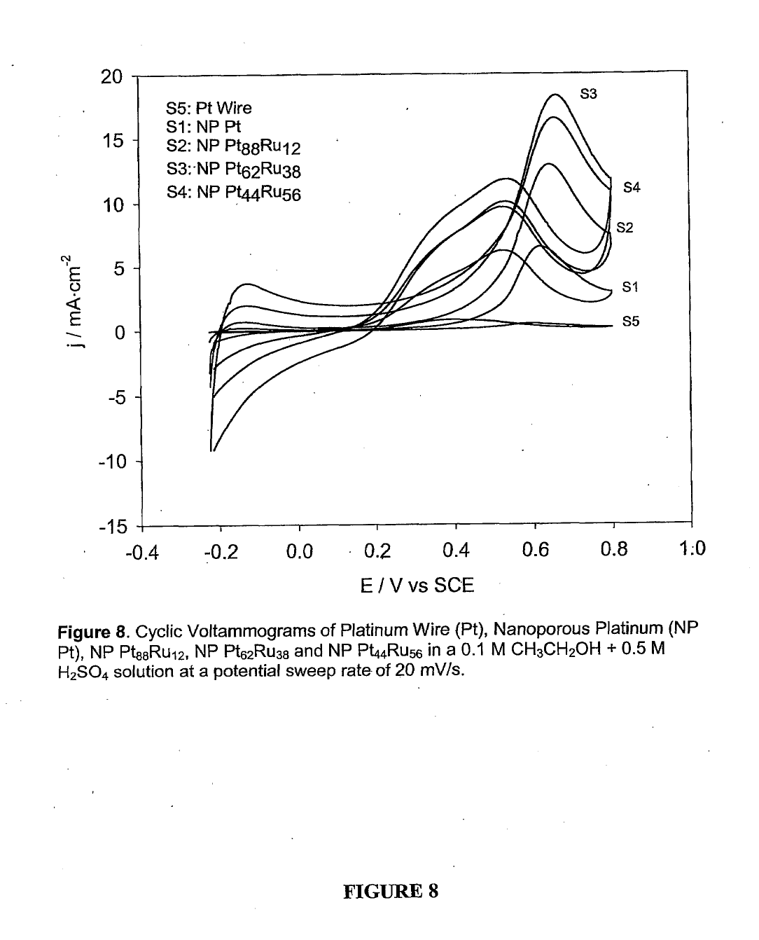

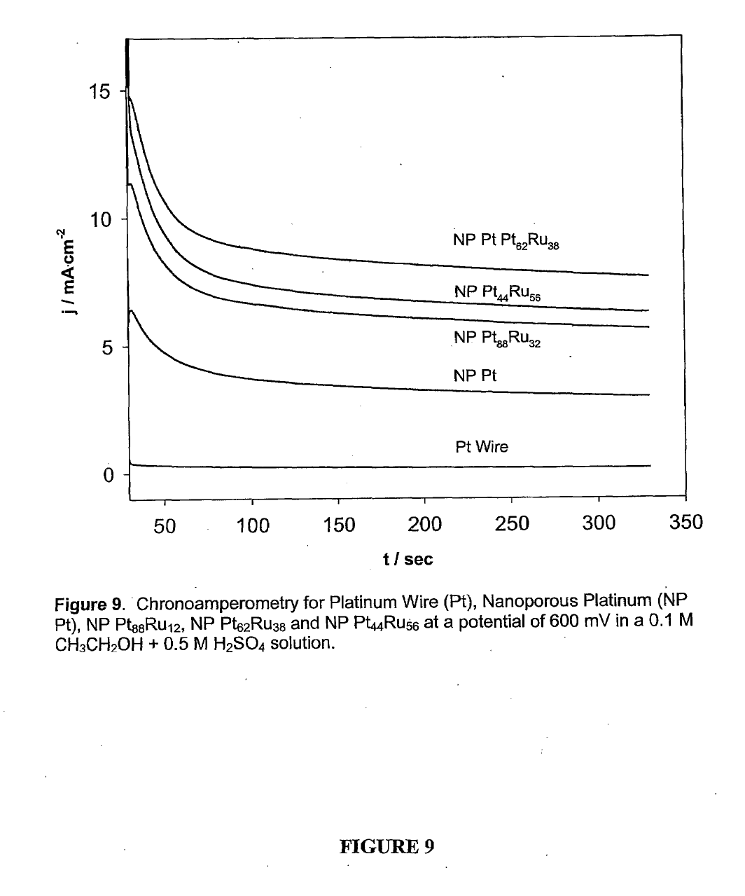

Another factor towards the DMFC, was the catalyst's activity towards methanol oxidation. FIG. 7(a) shows forward CV curves in a 0.1 M CH₃OH+0.5 M H₂SO₄ solution at a potential scan rate of 20 mV/s. The onset of methanol oxidation was lowered as the ruthenium concentration was increased. S3 and S4 showed a very similar active surface as calculated for the hydrogen adsorption; however, when the ruthenium concentration was past 50%, S4, a decrease in the activity of the sample was observed. This is consistent with findings that the maximum activity towards CO oxidation was achieved by a ruthenium concentration of 50% because the number of Pt—Ru neighbours was maximized resulting in more nucleation sites. To further study the activity of the electrodes, chronoamperometry was utilized. Potentials were held at 0.0 V for 30 seconds, and then stepped up to 300 mV and 600 mV respectively (FIGS. 7(b) and 7(c)). Steady-state currents for methanol electrooxidation were achieved after 300 seconds. At a potential of 300 mV, the steady-state currents for S1-S5 are 0.40 mA·cm⁻², 1.85 mA mC, 3.37 mA·cm⁻², 4.36 mA·cm⁻² and 0.0143 mA·cm⁻². Samples S1-S4 all exhibited much higher activities the S5, especially S3 and S4 whose steady state currents were over 200 times that of S5. When a potential of 600 mV, FIG. 7(c), was used, similar results were achieved with all samples showing superior activity versus polycrystalline Pt. S3 had the highest steady state current at just under 25 mA·cm⁻². These results were consistent with those shown in FIG. 7(a). Similarly, the results of CV and chronoamperometry studies using the electrodes for ethanol oxidation are shown in FIGS. 8 and 9.

Charge transfer resistance and capacitance measurements were done by way of electrochemical impedance spectroscopy. FIG. 7(d) illustrates four Nyquist plots at a potential of 300 mV in a solution of 0.1 M CH₃OH+0.5 M H₂SO₄, with the equivalent circuit used for fitting shown as an inset. The real and imaginary components of the impedance are represented by Zᵣ and Zᵢ and the shift in frequency was from 40 kHz to 40 mHz. A decrease in size was observed going from sample S1 go S4. Briefly, Rₛ represents the uncompensated solution resistance, R_{ct} represents the charge transfer resistance and CPE, defined as CPE_T and CPE_P, represents the constant phase element which takes into account methanol adsorption and oxidation. Samples S1 to S4 all showed a CPE_T value of approximately 0.95 which indicates the CPE_T values were close to the double layer capacitance C_{dl}. The charge transfer resistance for the smallest impedance curve, S4, is 21.92 Ω·cm² which is over 325 time smaller than that of polycrystalline Pt (7178 Ω·cm²). These results show that the addition of ruthenium to platinum to make 3D nanoporous PtRu alloy network electrodes increased the activity compared to polycrystalline Pt.

In conclusion, the inventors have successfully fabricated novel 3D nanoporous Pt and PtRu alloy network electrodes from a one step, hydrothermal method. The electrochemical studies performed indicate these samples contain a higher surface area, over 100 times for S3 and S4, than polycrystalline Pt as well as improved activity for CO oxidation and methanol oxidation. S3 and S4, with ruthenium concentrations of 38% and 56% showed desirable eletrocatalytic activity for electrochemical sensor design and fuel cell applications.

### Example 8

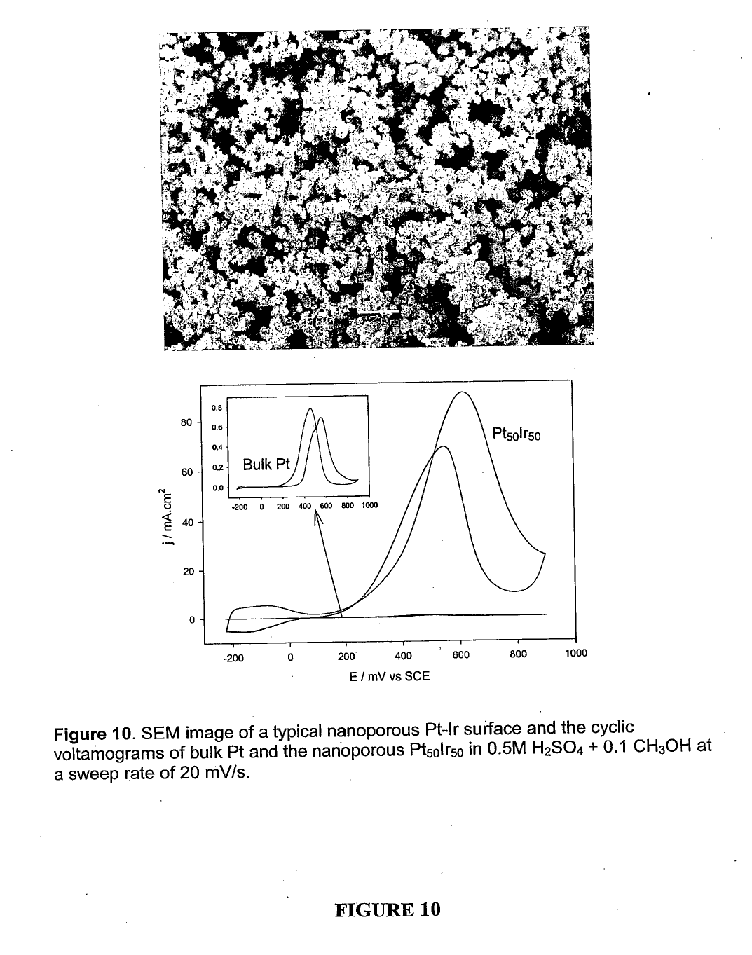

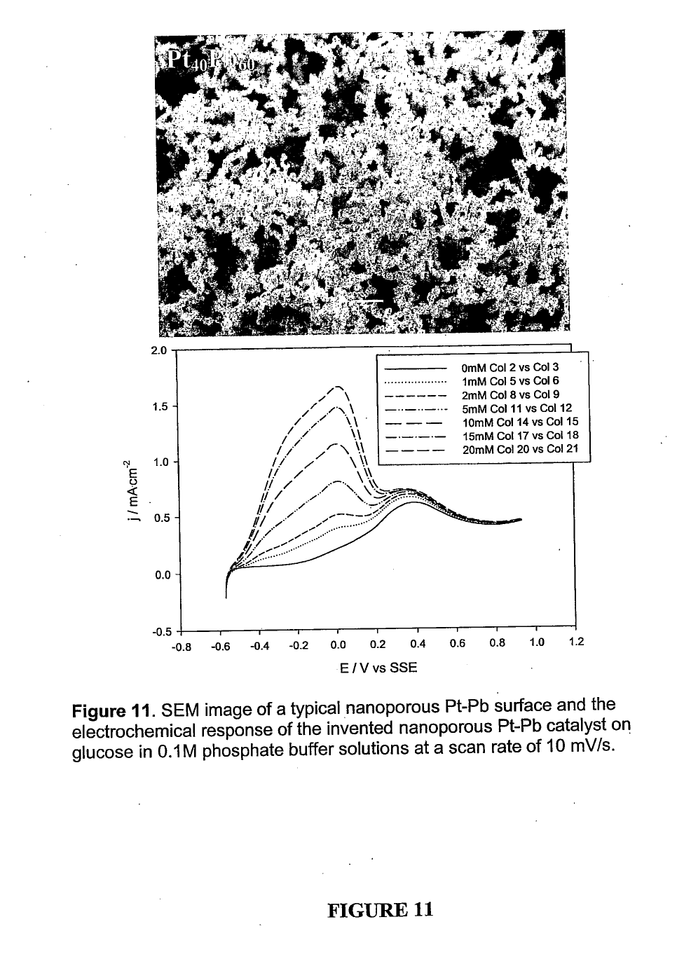

Nanoporous PtIr nanomaterial electrodes were made in the following manner: pieces of titanium foil were washed with Nanopure water (18.2 MΩ cm), then etched in an 18% HCl solution at 85° C. for 10 minutes to remove the oxide layer on the titanium surface. The etched substrate pieces were then washed once more and transferred to a teflon autoclave containing formaldehyde (HCHO), H₂PtCl₆*6H₂O dissolved in water and IrCl₃ dissolved in isopropyl alcohol), and heated at 180° for 10 hours. After cooling to room temperature, the coated substrates were removed, air dried, then rinsed with Nanopure water. This process resulted in the synthesis of the 3D novel nanoporous PtIr materials as shown in the SEM image in FIG. 10. As shown in FIG. 11, the invented nanoporous PtIr materials exhibit improved electrochemical activity for methanol oxidation. The peak current of the nanoporous PtIr electrode material is over 100 times larger than that of the bulk Pt, desirable for methanol fuel cell applications.

### Example 9

Nanoporous PtPb nanomaterial electrodes were made in the following manner: pieces of titanium foil were washed with Nanopure water (18.2 MΩ cm), then etched in an 18% HCl solution at 85° C. for 10 minutes to remove the oxide layer on the titanium surface. The etched substrate pieces were then washed once more and transferred to a teflon autoclave containing formaldehyde (HCHO), H₂PtCl₆*6H₂O and Pb(NO₃)₂, and heated at 180° for 14 hours. After cooling to room temperature, the coated substrates were removed, air dried, then rinsed with Nanopure water. This process resulted in the synthesis of the 3D novel nanoporous PtPb materials as shown in the SEM image in FIG. 1. As shown in FIG. 10, the invented nanoporous PtPb materials exhibit excellent electrochemical response on glucose, desirable for the development of non-enzymatic electrochemical glucose sensor.

It will be appreciated by those skilled in the relevant arts, from a reading of the disclosure, that various changes in form and detail can be made without departing from the true scope of the invention in the appended claims.

While the invention has been described and illustrated in connection with preferred embodiments, many variations and modifications, as will be evident to those skilled in the relevant arts, may be made without departing from the spirit and scope of the invention; and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect, or import of the methods described.

1. A method of fabricating a nanoporous material, the method comprising the steps of:
(i) heating a substrate in the presence of at least one reducing agent and at least one precursor solution; and
(ii) cooling the resulting nanoporous material.

2. The method according to claim 1, wherein the substrate comprises at least one component selected from the group consisting of titanium, tantalum, zirconium, platinum, gold, and carbon.

3. The method according to claim 1, wherein the substrate is titanium.

4. The method according to claim 1, wherein the nanoporous material is platinum-based.

5. The method according to claim 1, further comprising the step of washing the substrate before it is heated.

6. The method according to claim 1, further comprising the step of etching the substrate before heating it in order to substantially remove any oxide layer from the substrate.

7. The method according to claim 6, further comprising the step of electrodepositing platinum nanoparticles on the etched substrate at a suitable current.

8. The method according to claim 1, further comprising the step of washing the nanoporous material with a suitable solvent once it has cooled.

9-10. (canceled)

11. The method according to claim 1, wherein the at least one reducing agent is selected from the group consisting of ethylene glycol, formaldehyde, formic acid, and NaBH₄.

12. The method according to claim 1, wherein the at least one precursor solution is M₁, M₁+M₂ or M₁+M₂+M₃, where M₁ can be selected from the group consisting of H₂PtCl₆.xH₂O, PtCl₄, and PtCl₂ X g/L; and M₂ and M₃ can independently be selected from the group consisting of IrCl₃.yH₂O, RuCl₃.yH₂O, BiCl₃, AuCl₃, RhCl₃, PbCl₂, Pb(NO₃)₂, PdCl₂, and WCl₆×g/L.

13. The method according to claim 12, wherein x is in the range between 0 and 6, X is in the range of about 0.1 and about 32, and y is in the range of about 0 to 3.

14-18. (canceled)

19. A nanoporous material fabricated according to the method defined in claim 1.

20. The nanoporous material of claim 19, wherein the material is platinum-based.

21. The nanoporous material of claim 19, wherein the nanoporous material comprises pores with diameters in the range of about 0.1 nm (nano-meter) to about 1 micrometer in at least one dimension.

22-23. (canceled)

24. The nanoporous material of claim 19, wherein the nanoporous material is substantially non-mesoporous.

25. A nanoporous material comprising pores with diameters in the range of about 0.1 nm to about 1 micrometer in at least one dimension, wherein the nanoporous material is substantially non-mesoporous, and is platinum-based.

26-39. (canceled)

40. A method of detecting a substrate in a sample using the nanoporous material as defined in claim 19, said method comprising the steps of:
(i) contacting the nanoporous material with the sample to enable the substrate to interact with the nanoporous material and produce a signal; and
(ii) detecting the signal.

41. The method according to claim 40, wherein the nanoporous material is platinum-based.

42. The method according to claim 40, wherein the signal is an electric signal.

43. The method according to claim 42, wherein the signal is detected by a response current generated by applying a voltage to the nanoporous material.

44. The method of claim 40, wherein the nanoporous material is substantially free of any immobilized enzyme.

45. The method according to claim 40, wherein the substrate is a saccharide, an alcohol or carbon monoxide.

46. The method according to claim 40, wherein the substrate is selected from the group consisting of glucose, galactose, fructose, lactose, maltose, sucrose, methanol, ethanol and isopropanol.

47. The method according to claim 40, wherein the sample is selected from the group consisting of water, blood, urine, serum, and PBS buffer.

48. The method according to claim 42, wherein the current generated from the signal is measured amperometrically.

49. The method according to claim 48, wherein the current generated is proportional to the substrate present in the sample.

50. A biochemical substrate detector comprising the nanoporous material as defined in claim 19.

51. A fuel cell electrode comprising the nanoporous material as defined in claim 19.

52. A catalyst for the electro-oxidation of an organic species comprising the nanoporous material as defined in claim 19.

53. The method according to claim 40, wherein the substrate is a biochemical substrate.
